(19) United States
(12) Patent Application Publication
(10) Pub. No.: US 2025/0300678 A1
(43) Pub. Date: Sep. 25, 2025

(54) PHASED ARRAY INTERNAL LOOPBACK

(71) Applicant: QUALCOMM INCORPORATED, San Diego, CA (US)

(72) Inventors: Chinmaya MISHRA, San Diego, CA (US); Chirag Dipak PATEL, San Diego, CA (US); Damin CAO, San Diego, CA (US)

(21) Appl. No.: 18/610,860

(22) Filed: Mar. 20, 2024

(51) Int. Cl. H04B 1/00

(52) U.S. Cl. CPC H04B 1/0075

(57) ABSTRACT

A method of operating a transceiver integrated circuit includes: mixing a first oscillator signal, of a first oscillator signal frequency, and an IF transmit signal to produce an RF transmit signal, the IF transmit signal having a first IF and being received from am IF input/output port; providing the RF transmit signal to a plurality of phase shifters and a plurality of power amplifiers; mixing a second oscillator signal and an RF feedback signal to produce an IF feedback signal, the RF feedback signal being received from an output of one of the power amplifiers, and the IF feedback signal having a second IF that is different from the first IF; and providing the IF feedback signal to the IF input/output port.

### BACKGROUND

Wireless communication devices are increasingly popular and increasingly complex. For example, mobile telecommunication devices have progressed from simple phones, to smart phones with multiple communication capabilities (e.g., multiple cellular communication protocols, Wi-Fi®, BLUETOOTH® and other short-range communication protocols), supercomputing processors, cameras, etc. Wireless communication devices have antennas to support various functionality such as communication over a range of frequencies, reception of Global Navigation Satellite System (GNSS) signals, also called Satellite Positioning Signals (SPS signals), etc.

With several antennas disposed in a single wireless communication device, available volume for antennas is at a premium. For example, smartphones may have numerous antennas (e.g., eight antennas, 10 antennas, or more) with very limited volume due to the size of devices that consumers desire. Consequently, antenna assemblies (e.g., modules) may be limited to very small volumes, e.g., with widths of 4 mm or less.

Despite the volume restrictions for antennas, desired functionality of the antennas continues to increase. With the advent of 5th generation (5G) of wireless communication technology, mmW (millimeter-wave) phased array antennas have received extensive attention to address the propagation loss and aperture blockage hurdles by introducing higher antenna gain and beamforming features. Multiple-input-multiple-output (MIMO) systems is one of the key enablers of 5G technology to increase the spectral efficiency and system capacity by effectively streaming the transmit/receive data with two orthogonally polarized signals (cross-polarized signals) in desired directions. The trend in consumer electronics is to develop RF (Radio Frequency) assemblies (radio frequency assemblies) with small form factors which can be easily accommodated within the limited space of the emerging smart devices including cell phones and tablets. The physical requirements of antennas make maintaining or improving performance (e.g., in terms of coverage, latency, and quality of service over desired coverage area) difficult.

Production of wireless communication devices, including millimeter-wave integrated circuit (IC) production, is costly in terms of test procedures, equipment, and testing time, and may be impractical to perform after manufacture, e.g., during mission operation. On-chip built-in self-test (BIST) circuitry may reduce cost, including testing time, but presents challenges to enable accurate test results.

### SUMMARY

An example transceiver integrated circuit includes: a first intermediate frequency input/output port; a first transceiver subcircuit including: a plurality of first power amplifiers each including a respective first power-amplifier output, of a plurality of first power-amplifier outputs, that is selectively communicatively coupled to a first radio frequency input/output port; and a plurality of first phase shifters each communicatively coupled to a first power-amplifier input of a respective one of the plurality of first power amplifiers; a first oscillator configured to provide a first oscillator signal of a first oscillator signal frequency; a first mixer communicatively coupled to the first intermediate frequency input/output port, communicatively coupled to the first oscillator, and communicatively coupled to the plurality of first power amplifiers via the plurality of first phase shifters, wherein the first mixer is configured to mix a first transmit signal, received from the first intermediate frequency input/output port, with the first oscillator signal to change a frequency of the first transmit signal from a first intermediate frequency to a first radio frequency; a second oscillator configured to provide a second oscillator signal of a second oscillator signal frequency that is different from the first oscillator signal frequency; and a second mixer communicatively coupled to the first intermediate frequency input/output port, communicatively coupled to the second oscillator, and selectively communicatively coupled to the first power-amplifier output of at least one of the plurality of first power amplifiers, wherein the second mixer is configured to mix a first feedback signal, received from the first power-amplifier output of a respective one of the plurality of first power amplifiers, with the second oscillator signal to change a frequency of the first feedback signal from the first radio frequency to a second intermediate frequency that is different from the first intermediate frequency.

An example method of operating a transceiver integrated circuit includes: mixing a first oscillator signal, of a first oscillator signal frequency, and an IF transmit signal to produce an RF transmit signal, the IF transmit signal having a first IF and being received from am IF input/output port; providing the RF transmit signal to a plurality of phase shifters and a plurality of power amplifiers; mixing a second oscillator signal and an RF feedback signal to produce an IF feedback signal, the RF feedback signal being received from an output of one of the power amplifiers, and the IF feedback signal having a second IF that is different from the first IF; and providing the IF feedback signal to the IF input/output port.

Another example transceiver integrated circuit includes: means for mixing a first oscillator signal and a first intermediate frequency transmit signal to produce a first radio frequency transmit signal, the first oscillator signal having a first oscillator signal frequency, the first intermediate frequency transmit signal having a first intermediate frequency and being received from a first intermediate frequency input/output port; means for providing the first radio frequency transmit signal to a first transceiver subcircuit that includes a plurality of first phase shifters and a plurality of first power amplifiers each coupled to an output of one of the plurality of first phase shifters; means for mixing a second oscillator signal, of a second oscillator signal frequency, and a first radio frequency feedback signal to produce a first intermediate frequency feedback signal, the first radio frequency feedback signal being received from an output of one of the plurality of first power amplifiers, and the first intermediate frequency feedback signal having a second intermediate frequency that is different from the first intermediate frequency; and means for providing the first intermediate frequency feedback signal to the first intermediate frequency input/output port.

### BRIEF DESCRIPTION OF THE DRAWINGS

FIG. 1 is a schematic diagram of a communication system.

FIG. 2 is a block diagram of a transceiver of a user equipment, and possible components of the user equipment.

FIG. 3 is a block diagram of an example user equipment.

FIG. 4 is a block diagram of an example of the transceiver shown in FIG. 3.

FIG. 5 is a frequency diagram of a low-pass filter and a high-pass filter relative to an intermediate frequency transmit band and an intermediate frequency feedback band.

FIG. 6 is a block diagram of components of the transceiver shown in FIG. 4, an intermediate frequency integrated circuit, and a modem.

FIG. 7 is simplified circuit diagram of an example interface, showing frequency responses of various components of the interface.

FIG. 8 is block flow diagram of an example method of operating a transceiver integrated circuit.

### DETAILED DESCRIPTION

Techniques are discussed herein for built-in self-test of an integrated circuit, e.g., a millimeter-wave transceiver integrated circuit (IC). For example, a transmit signal at a first intermediate frequency (IF) that is provided to an intermediate frequency input/output (I/O) port (e.g., an electrically-conductive bump for connecting the transceiver IC to an IF IC) may be mixed, by a first mixer, with a first local oscillator (LO) signal to produce a radio frequency (RF) transmit signal. The RF transmit signal is provided to multiple phase shifters and respective power amplifiers (PAs) for provision to respective antenna elements of a phased array antenna. A selected one of the PA outputs may be fed back and mixed, by a second mixer, with a second LO signal to produce an IF feedback signal at a second IF that is different from the first IF. The IF feedback signal may be provided to the IF I/O port concurrently with the transmit signal being present at the IF I/O port, such that frequency diversity of the two IF signals exists concurrently at the IF I/O port. Filtering may be applied to inhibit energy of the second IF from reaching the first mixer and energy of the first IF from being provided by the second mixer to the IF I/O port. The first mixer may be a component of a first transceiver subcircuit for transmitting and receiving RF signals in a first RF band and the second mixer may be a component of a second transceiver subcircuit for transmitting and receiving RF signals in a second RF band that is different from the first RF band. Other configurations, however, may be used.

Items and/or techniques described herein may provide one or more of the following capabilities, as well as other capabilities not mentioned. An integrated circuit (IC) substrate may have a self-test function and thus performance of the IC substrate may be self-tested and production cost (e.g., testing time) may be reduced, e.g., without using external equipment. Self-test and calibration (e.g., digital pre-distortion calibration) may be performed on a transceiver IC after production, e.g., in the field. Intermediate frequency ports/cables may be used to enable real-time feedback of transmit signals for additional processing (e.g., digital predistortion and antenna impedance measurements/tuning). An output of each power amplifier supporting a phased array antenna may be sampled one at a time during manufacture (in a calibration mode) or in a mission mode after manufacture. Outputs of power amplifiers in larger arrays, possibly in multiple integrated circuits, may be sampled and the choice of power amplifier to be sampled may be based on information from other detectors associated with individual power amplifier elements. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

The discussion herein focuses on communication systems, and in particular mmW (millimeter-wave) communication systems. The techniques discussed herein, however, may be used for other applications and/or other frequencies, for example FR3 or sub-THz.

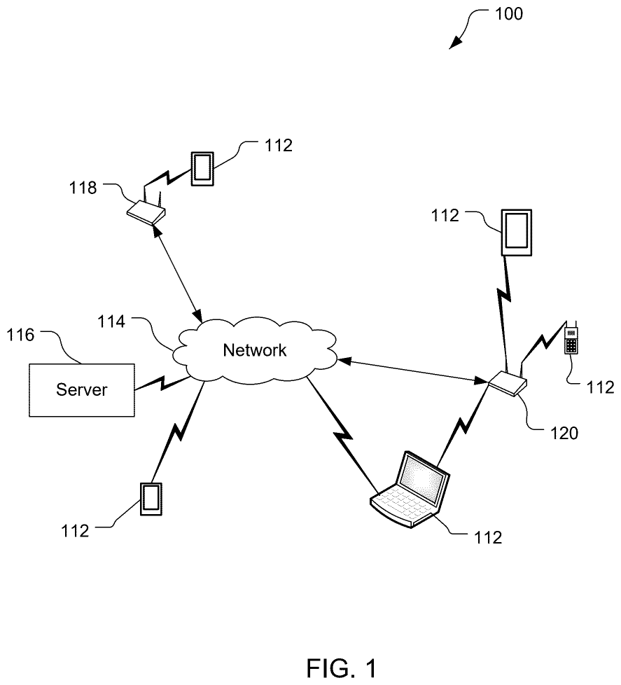

Referring to FIG. 1, a communication system 100 includes mobile devices 112, a network 114, a server 116, and access points (APs) 118, 120. The communication system 100 is a wireless communication system in that components of the communication system 100 can communicate with one another (at least sometimes) using wireless connections directly or indirectly, e.g., via the network 114 and/or one or more of the access points 118, 120 (and/or one or more other devices not shown, such as one or more base transceiver stations). For indirect communications, the communications may be altered during transmission from one entity to another, e.g., to alter header information of data packets, to change format, etc. The mobile devices 112 shown are mobile wireless communication devices (although they may communicate wirelessly and via wired connections) including mobile phones (including smartphones), a laptop computer, and a tablet computer. Still other mobile devices may be used, whether currently existing or developed in the future. Further, other wireless devices (whether mobile or not) may be implemented within the communication system 100 and may communicate with each other and/or with the mobile devices 112, network 114, server 116, and/or APs 118, 120. For example, such other devices may include internet of thing (IoT) devices, medical devices, home entertainment and/or automation devices, automotive devices, etc. The mobile devices 112 or other devices may be configured to communicate in different networks and/or for different purposes (e.g., 5G, Wi-Fi® communication, multiple frequencies of Wi-Fi® communication, satellite communication and/or positioning, one or more types of cellular communications (e.g., GSM (Global System for Mobiles), CDMA (Code Division Multiple Access), LTE (Long-Term Evolution), etc.), Bluetooth® communication, etc.). Each of the mobile devices 112 may be referred to as a user equipment (UE).

As used herein, the term “user equipment” and “UE” are not specific to or otherwise limited to any particular Radio Access Technology (RAT), unless otherwise noted. In general, UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on. Further, two or more UEs may communicate directly in some configurations with or without passing information to each other through a network.

User equipment are often configured with one or more phased-array antenna systems that use Digital Pre-Distortion (DPD) to improve performance. A phased-array antenna system may include multiple phase shifters and corresponding power amplifiers to provide a transmit signal to different antenna elements with different phase shifts to direct an antenna beam in a desired direction. Digital Pre-Distortion may be used to compensate for non-linearity of the power amplifiers and DPD calibration may be performed to help ensure that proper DPD is applied when the antenna system is in use. DPD calibration may be performed during manufacture of a UE using over-the-air (OTA) loopback signals. While it is desired to capture a transmit signal at the highest available level (as that is where power amplifier linearity is typically best), due to strong mutual coupling between antenna elements, a receive chain may be desensitized due to the limit of acceptable signal power level in the receive chain. Using low receive chain gain states may not be acceptable because a signal traveling through the receive chain degrades linearity and may add noise in excess of the attenuation of the receive chain. Consequently, loopback testing through mutual coupling depends on the UE configuration, e.g., the amount of mutual coupling between antenna elements and the attenuation of the receive chain. Over-the-air loopback testing may result in large variations across frequencies and components, suggesting that mutual coupling calibration be performed prior to DPD training. Mutual coupling calibration, however, may undesirably increase factory calibration time and cost. Further, housing effects may result in incorrect calibration.

Techniques discussed herein may improve DPD calibration, e.g., by avoiding mutual coupling calibration avoiding OTA loopback calibration. For example, an internal (non-OTA) signal loopback (feedback) may be used for DPD and/or other applications, e.g., antenna impedance detection for antenna tuner control. Techniques are discussed herein for using an internal loopback of a transmit signal taken from the output of a power amplifier as part of a phased array antenna system. Techniques discussed herein (e.g., internal signal loopback) may facilitate or even enable online calibration which may facilitate large-array DPD calibration.

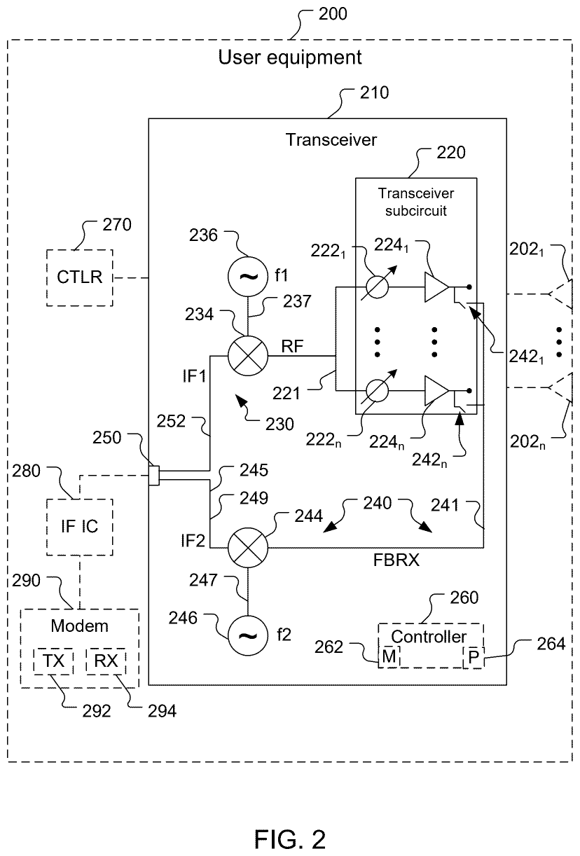

Referring to FIG. 2, a transceiver 210, which may be a component of a device, in this example a UE 200, includes a transceiver subcircuit 220, a transmit signal circuit 230, a feedback signal circuit 240, and an I/O port 250 (input/output port). The transceiver 210 may be configured to provide internal receive signal feedback for use in calibration, e.g., DPD calibration. The transceiver 210 may include a controller 260 configured to control portions of the transmit signal circuit 230 and the feedback signal circuit 240 to provide internal feedback for calibration with a transmit signal and a feedback signal of different frequencies coexisting (i.e., being present concurrently) at the I/O port 250. Alternatively, the device, in this example the UE 200, containing the transceiver 210 may include a controller 270 that is communicatively coupled to the transceiver 210. The controller 270 may be configured to control (e.g., as discussed below with respect to the controller 260) portions of the transmit signal circuit 230 and the feedback signal circuit 240 to provide internal feedback for calibration with a transmit signal and a feedback signal of different frequencies coexisting at the I/O port 250. The UE 200 may include an IF IC 280 and a modem 290 communicatively coupled to the transceiver 210. The modem 290 may comprise a transmit circuit 292 that provides a signal source, being configured to provide transmit signals to the I/O port 250. The modem 290 may comprise a receive circuit 294 configured to receive and process (e.g., measure and/or decode) signals received from the I/O port 250. The I/O port 250 may comprise, for example, an electrically-conductive bump configured to be connected to the IF IC 280, or a transmission line connected to the IF IC 280.

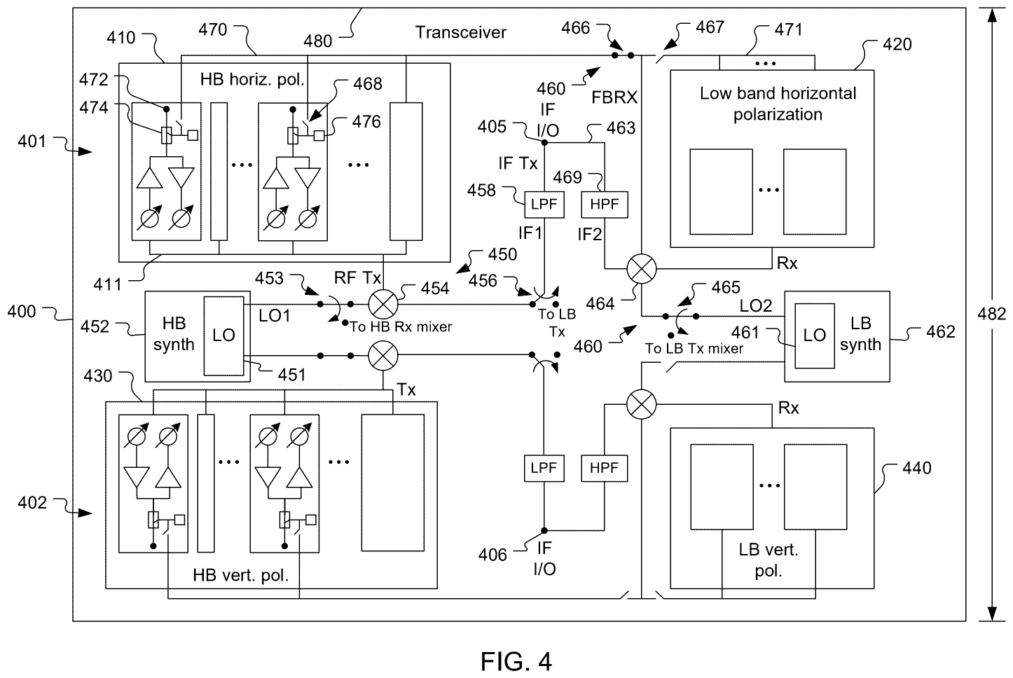

The transceiver subcircuit 220 may be configured to transmit and receive desired signals, e.g., of desired frequency and of desired polarization (e.g., horizontal and/or vertical polarization), although receive circuitry (e.g., low-noise amplifiers and receive phase shifters) is not shown in FIG. 2 (but is partially shown in FIG. 4). The transceiver subcircuit 220 includes multiple phase shifters 222₁-222ₙ and multiple power amplifiers 224₁-224ₙ each corresponding to one the phase shifters 222₁-222ₙ. Outputs of the power amplifiers 224₁-224ₙ are connected to ports configured to be communicatively coupled to respective antenna elements 202₁-202ₙ.

The transmit signal circuit 230 includes a mixer 234 and an oscillator 236. The mixer 234 is communicatively coupled to the I/O port 250, and is communicatively coupled to the oscillator 236. The oscillator 236 is configured to provide a first oscillation signal 237 of a first oscillator signal frequency f1 (e.g., within a first frequency band). The mixer 234 is configured to mix a transmit signal 252 (of a first intermediate frequency IF1, e.g., with a frequency in a first IF band) from the I/O port 250 with the first oscillation signal 237 to change the frequency of the transmit signal from IF1 to an RF transmit signal (RF Tx) with a radio frequency. The mixer 234 may provide the RF transmit signal RF Tx to the transceiver subcircuit 220, and in particular to the phase shifters 222₁-222ₙ through a distribution network 221 of transmission lines. The transceiver subcircuit 220 is configured to phase shift and amplify the RF transmit signal into multiple RF transmit signals.

The feedback signal circuit 240 may be configured to selectively feedback an RF transmit signal from the output of one of the power amplifiers 224₁-224ₙ as a feedback receive signal 241 (FBRX), change a frequency of the FBRX signal to produce a frequency-changed FBRX signal, and provide the frequency-changed FBRX signal to the I/O port 250. The feedback signal circuit 240 may include switches 242₁-242ₙ, a mixer 244, and an oscillator 246. Each of the switches 242₁-242ₙ corresponds to one of the outputs of the power amplifiers 224₁-224ₙ, with the switches 242₁-242ₙ not being directly connected to the power amplifiers 224₁-224ₙ, but coupled to respective coupled ports of respective couplers that each couples part of a signal from a respective one of the power amplifiers 224₁-224ₙ. The mixer 244 is selectively communicatively coupled to each of the outputs of the power amplifiers 224₁-224ₙ. The mixer 244 may be communicatively coupled to a respective one of the outputs of the power amplifiers 224₁-224ₙ to receive a feedback signal from the respective one of the power amplifiers 224₁-224ₙ. For example, one of the switches 242₁-242ₙ may be closed while the other switches of the switches 242₁-242ₙ are opened (or left open) in order to couple the RF transmit signal from a selected one of the power amplifiers 224₁-224ₙ as the FBRX signal 241 to the mixer 244. The mixer 244 is communicatively coupled to the oscillator 246 and is communicatively coupled to the I/O port 250. The oscillator 246 is configured to provide a second oscillation signal 247 of a second oscillator signal frequency f2 (e.g., within a second frequency band) that is different from the first oscillator signal frequency f1. The mixer 244 is configured to mix the FBRX signal 241 from the transceiver subcircuit 220 with the second oscillation signal 247 to produce an IF feedback signal 245 by changing the frequency of the FBRX signal 241 from RF to a second intermediate frequency IF2 that is different from the first intermediate frequency IF1 of the transmit signal 252. The IF feedback signal 245 may be conveyed to the I/O port 250 from the mixer 244 by a transmission line 249. The FBRX signal of the second intermediate frequency IF2 (the IF feedback signal 245) and the transmit signal 252 of the first intermediate frequency IF1 may be present at the I/O port 250 at the same time. The oscillator 246 is configured such that the first intermediate frequency IF1 and the second intermediate frequency IF2 are sufficiently different (e.g., within different IF bands that are sufficiently different) such that one filter may be applied to the combined signals to pass the transmit signal 252 and suppress the IF feedback signal 245 and another filter may be applied to the combined signals to pass the IF feedback signal 245 and suppress the transmit signal 252. Each of these filters may have a respective cutoff frequency between the first intermediate frequency IF1 and the second intermediate frequency IF2. A filter may be considered to pass a signal if, for example, the filter attenuates the signal by less than 0.5 dB (with, for example, signal droop across the pass band of less than 1 dB) and may be considered to suppress a signal if, for example, the filter attenuates the signal by at least 5 dB.

The mixer 244 (and possibly one or more other components of the feedback signal circuit 240) may not be associated with any particular frequency band. The mixer 244 may be used for feedback from the transceiver subcircuit 220 or another transceiver subcircuit.

The controller 260 may be configured to control the switches 242₁-242ₙ to selectively couple an output of one of the power amplifiers 224₁-224ₙ to the mixer 244. The controller 260 may comprise memory 262 and a processor 264. The memory 262 may include one or more memories and/or the processor 264 may include one or more processors. The processor 264 may include the memory 262 or a portion of the memory 262. The processor 264 may comprise multiple processors including a general-purpose/application processor, a Digital Signal Processor (DSP), etc. The memory 262 may be a non-transitory storage medium that may include random access memory (RAM), flash memory, disc memory, and/or read-only memory (ROM), etc. The memory 262 may store software which may be processor-readable, processor-executable software code containing processor-readable instructions that may be configured to, e.g., when executed, cause the processor 264 to perform various functions described herein. Alternatively, the software may not be directly executable by the processor 264 but may be configured to cause the processor 264, e.g., when compiled and executed, to perform the functions. The description herein may refer to the processor 264 performing a function, but this includes other implementations such as where the processor 264 executes software and/or firmware. The description herein may refer to the processor 264 performing a function as shorthand for one or more processors performing the function. The description herein may refer to the controller 260 performing a function as shorthand for one or more processors of the controller 260 performing the function. The processor 264 may include a memory with stored instructions in addition to and/or instead of the memory 262. For the sake of simplicity of FIG. 2 (and other figures), numerous components are omitted from the figures as well as some connections between components. For example, the controller 260 is communicatively coupled to numerous components, e.g., switches, as discussed herein but these connections are not shown in FIG. 2.

The UE 200 is an example, and other configurations of UEs (or other devices) may be used, including other configurations of the transceiver 210. The transceiver 210 comprises an integrated circuit (IC) substrate formed, e.g., from silicon (and/or one or more other semiconductors) and one or more conductors. The transceiver 210 may be configured for transmitting and receiving communication signals, e.g., millimeter-wave communication signals. The transceiver subcircuit 220 may be configured for sending and/or receiving a particular polarization of signals, e.g., horizontal-polarization signals.

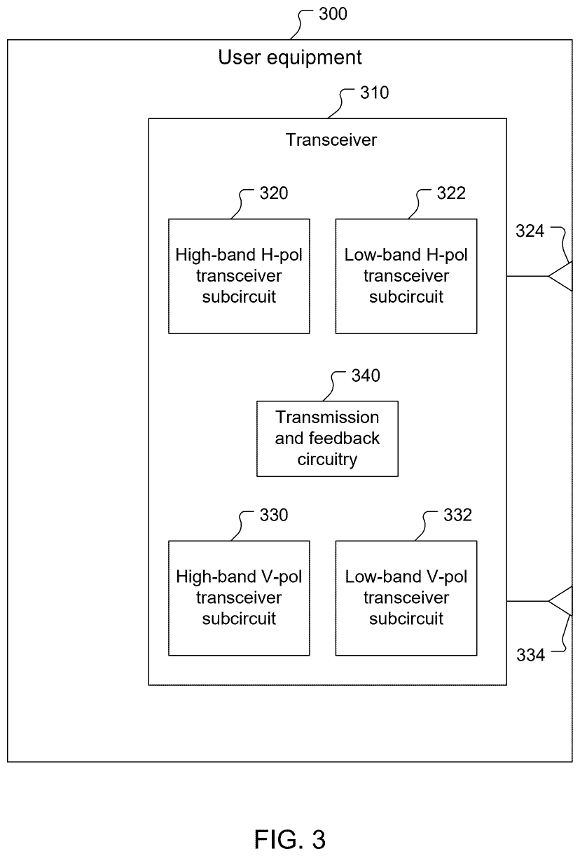

Referring also to FIG. 3, a UE 300 is an example of the UE 200 and includes a transceiver 310 that is an example of the transceiver 210. The transceiver 310 comprises more than one transceiver subcircuit, here transceiver subcircuits 320, 322, 330, 332, with different subcircuits configured to transmit and receive respective signals, e.g., of different frequencies and different polarizations. For example, the transceiver subcircuit 320 may be configured for sending and/or receiving high-band horizontal-polarization signals (as sent and received by a horizontally-polarized antenna 324). The transceiver subcircuit 322 may be configured for sending and/or receiving low-band horizontal-polarization signals (as sent and received by the horizontally-polarized antenna 324). The transceiver subcircuit 330 may be configured for sending and/or receiving high-band vertical-polarization signals (as sent and received by a vertically-polarized antenna 334). The transceiver subcircuit 332 may be configured for sending and/or receiving low-band vertical-polarization signals (as sent and received by the vertically-polarized antenna 334). The antennas 324, 334 may be communicatively coupled to respective transceiver subcircuits and may be implemented as a single antenna with dual polarization. The low-band signals are in a “low” frequency band that is lower than a “high” frequency band of the high-band signals. The low band and high band may, for example, comprise a low mmW band (e.g., 24 GHz-29.5 GHZ) and a high mmW band (e.g., 37 GHz-43.5 GHz). These frequency bands are examples, and other frequency bands (e.g., FR3, sub-THz, etc.) may be used. The transceiver 310 may include transmission and feedback circuitry 340 that is configured to direct transmit signals from one or more I/O ports to appropriate transmit circuitry (e.g., phase shifters, power amplifiers, and antenna elements) and to feed back one or more selected signals from one or more respective power amplifier outputs to the one or more I/O ports for measurement and analysis (e.g., externally to the transceiver 310 but within the UE 300).

Referring also to FIG. 4, a transceiver 400, which is an example of the transceiver 310, includes a high-band horizontal polarization unit 410, a low-band horizontal polarization unit 420, a high-band vertical polarization unit 430, and a low-band vertical polarization unit 440. The units 410, 420, 430, 440 each comprise respective transceiver subcircuits. The units 410, 420 may be parts of what is called a horizontal layer 401 or “H-layer” and the units 430, 440 may be parts of what is called a vertical layer 402 or “V-layer”. The H-layer 401 comprises circuitry for processing (e.g., generating, amplifying, measuring, and/or decoding, etc.) signals corresponding to (e.g., to be transmitted with and/or signals received with) a first polarization. The V-layer 402 comprises circuitry for processing (e.g., generating, amplifying, measuring, and/or decoding, etc.) signals corresponding to a second polarization that is different from, e.g., orthogonal to, the first polarization. Each of the units 410, 420, 430, 440 is disposed in a respective quadrant of the transceiver 400, e.g., in a respective quadrant of an integrated circuit chip comprising the transceiver 400.

In this example, feedback circuitry is provided in each of the layers 401, 402. Feedback circuitry is shown for feeding back a high-band transmit signal and using a low-band local oscillator signal (also used for the low-band units 420, 440) to reduce the feedback signals to IF for IF frequency multiplexing at respective I/O ports (of each layer) with respective transmit signals. Low-band transmit signals may be used as feedback signals, but much of the circuitry for implementing this is omitted from FIG. 4 for the sake of simplicity of the figure. Also, in this example, a local oscillator is used for low-band operation and for feedback signal mixing, and a mixer may be used for low-band receive signal processing and for feedback signal processing, but other configurations may be used, e.g., with a dedicated feedback oscillator and/or a dedicated feedback mixer.

The transceiver 400 includes high-band, H-layer transmit circuitry 450 including a local oscillator 451 of a high-band synthesizer 452, a mixer 454, a switch 456, and an LPF 458 (low-pass filter). The mixer 454 is selectively communicatively coupled to an H-layer IF I/O port 405 by the switch 456 and the LPF 458. The mixer 454 is configured to mix a local oscillator signal (LO1) from the local oscillator 451 with an IF transmit signal (IF Tx) from the IF I/O port 405 (of a first IF (IF1)) to produce an RF transmit signal (RF Tx), e.g., at a millimeter-wave frequency. The mixer 454 is communicatively coupled to phase shifters of transceiver subcircuits of the high-band horizontal polarization unit 410 to provide the RF transmit signal RF Tx to the phase shifters of the high-band horizontal polarization unit 410 through a distribution network 411 of transmission lines. The switch 456, in conjunction with another switch (not shown), may be used to direct the transmit signal (IF Tx) from the H-layer IF I/O port 405 to either the high-band horizontal polarization unit 410 or to the low-band horizontal polarization unit 420. Configurations other than the configuration shown in FIG. 4 may be implemented. For example, the switches 453, 456 may be omitted for an implementation where the H-layer transmit signal is always either in the high band or always in the low band, and the feedback signal is always in the other band (i.e., feedback signal being in the low band if the transmit signal is in the high band).

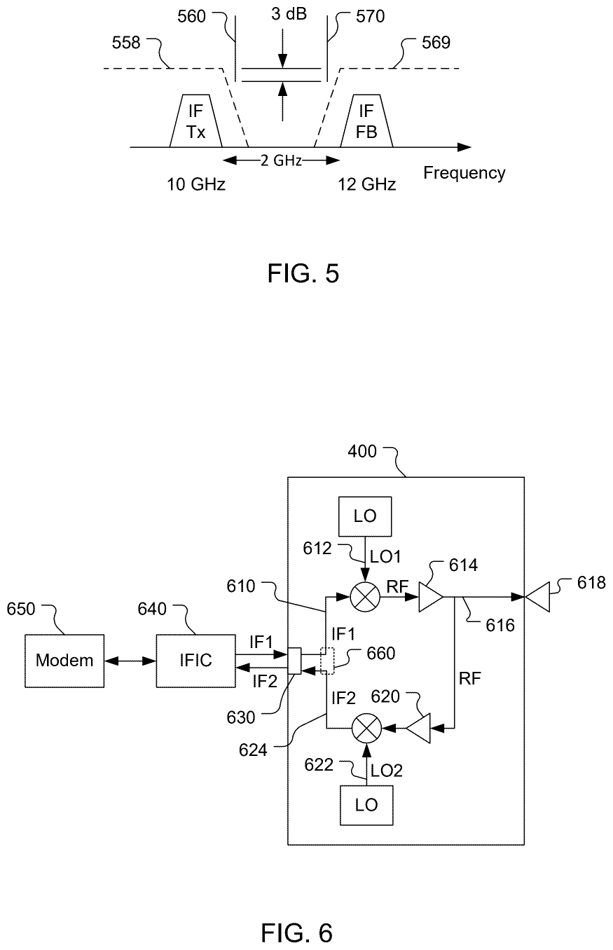

The transceiver 400 includes H-layer feedback circuitry 460 including a local oscillator 461 of a low-band synthesizer 462, a mixer 464, a switch 465, switches 466, 467, switches 468, an HPF 469 (high-pass filter), and feedback lines 470, 471. Input/output ports 472 of the unit 410 are disposed proximate to a side 480 of the transceiver 400 (e.g., within 20% of a width 482 of the transceiver 400 of an edge of an IC chip comprising the transceiver 400). The feedback line 470 is disposed and extends proximate to the side 480 as well, here with at least some of the feedback line 470 disposed between at least one of the input/output ports 472 (e.g., between all but one of the input/output ports 472) and the side 480. The switch 465 selectively communicatively couples the local oscillator 461 to the mixer 464 to selectively provide a local oscillator signal (LO2) to the mixer 464. The switch 465 may be used in conjunction with one or more other switches (not shown) such that different local oscillator frequencies may be provided to different mixers (e.g., for receive inter-carrier-aggregation) and/or to enable down conversion of a feedback signal from the low-band side using the local oscillator signal (LO1) from the high-band side. The switches 468 (i.e., the switches 242₁-242ₙ shown in FIG. 2) are configured to selectively communicatively couple outputs of power amplifiers of the high-band horizontal polarization unit 410 to the switch 466. The switches 468 may be coupled to respective couplers 474 that each couples part of a signal from a respective one of the power amplifiers. A power detector 476 may be communicatively coupled to each of the couplers 474 and configured to measure a signal power. Switches in the transceiver 400 are controlled by a controller (not shown), such as the controller 260. A controller (not shown), such as the controller 260, is configured to cause one (if any) of the switches 468 at a time to communicatively couple a respective power amplifier output to the switch 466. The switch 466 is configured to selectively communicatively couple the high-band horizontal polarization unit 410 to the mixer 464. The switch 467 and switches (not shown) in the low-band horizontal polarization unit 420 similar to the switches 468 in the high-band horizontal polarization unit 410 are configured to selectively communicatively couple one (if any) power amplifier output of the low-band horizontal polarization unit 420 to the mixer 464. The mixer 464 is configured to mix the local oscillator signal (LO2) from the local oscillator 461 with a feedback receive (FBRX) signal at radio frequency (e.g., at a millimeter-wave frequency) to produce an intermediate-frequency feedback signal with a second IF (IF2) that is different from the first IF (IF1). For example, referring also to FIG. 5, the transmit signal Tx has a first IF frequency (IF1) at the IF I/O port 405, e.g., about 10 GHz, and the intermediate-frequency feedback signal has a second IF frequency (IF2) of about 12 GHz such that a frequency separation between the IF Tx signal and the IF feedback (FB) signal is about 2 GHz. The LPF 458 is configured to pass the IF transmit signal (e.g., attenuate signals of the first IF by less than 0.5 dB) and to stop the IF feedback signal (e.g., suppress signals of the second IF by more than 5 dB). For example, a frequency response 558 of the LPF 458 may have an LPF cutoff frequency 560 between the first IF frequency and the second IF frequency. A transmission line 463 and the HPF 469 are configured to convey the IF feedback signal from the mixer 464 to the IF I/O port 405. The HPF 469 is configured to pass the IF feedback signal (e.g., attenuate signals of the second IF by less than 0.5 dB) and to stop the IF transmit signal (e.g., suppress signals of the first IF by more than 5 dB). For example, a frequency response 569 of the HPF 469 may have an HPF cutoff frequency 570 (attenuating by 3 dB) between the first IF frequency and the second IF frequency. Using the transceiver 400, signals may be concurrently transmitted from the different layers, e.g., transmitting using the high-band horizontal polarization unit 410 and either the high-band vertical polarization unit 430 or the low-band vertical polarization unit 440. Thus, one power amplifier from each layer can be simultaneously sampled (e.g., during manufacture, or during a mission mode while a device, e.g., a UE, containing the transceiver 400 is in use). In other configurations, only one layer at a time is operated, or only one layer is configured for feedback. The feedback circuitry 460 may make use of an appropriate LO frequency in order to separate the IF transmit signal and the IF feedback signal in frequency.

Both of the layers 401, 402 may be used for transmission concurrently, of the same or different bands, while switches ensure transmission by one of the bands (at most) in each of the layers 401, 402 at any given time. The switch 456 (for the horizontal layer 401) directs the IF Tx signal to either the high-band horizontal polarization unit 410 or the low-band horizontal polarization unit 420 at any given time (and a similar switch in the vertical layer 402 ensures transmission by either the high-band vertical polarization unit 430 or the low-band vertical polarization unit 440 at any given time). Switches are controlled by a controller to implement desired transmission and feedback. To use the high-band horizontal polarization unit 410 for transmission, the switch 456 directs the IF Tx signal (at IF1) to the mixer 454 and a switch 453 directs the local oscillator signal LO1 to the mixer 454. Concurrently, the switch 465 directs the local oscillator signal LO2 to the mixer 464 and the switch 466 directs the FBRX signal to the mixer 464. To use the low-band horizontal polarization unit 420 for transmission, the switch 456 would direct the IF Tx signal (at IF1) to a low-band (LB) Tx mixer (corresponding to the mixer 454) for the low-band horizontal polarization unit 420, and the switch 465 would direct the local oscillator signal LO2 to the LB Tx mixer. Concurrently, the switch 453 would direct the local oscillator signal LO1 to the mixer 464 for use in mixing the FBRX signal, and the switch 467 would direct the FBRX signal to the mixer 464. By producing appropriate local oscillator signal frequencies for the local oscillator signals LO1, LO2, the respective transmission signal IF Tx and the respective feedback signal FBRX may coexist concurrently at the respective IF I/O port 405, 406 in each of the layers 401, 402 due to frequency separation of the IF Tx and FBRX signals at each of the IF I/O ports 405, 406.

The frequency of the IF transmit signal and the frequency of the IF feedback signal may be the same regardless of the unit 410, 420, 430, 440 being used for transmission, e.g., by using appropriate LO frequencies. In this case, the same filters (e.g., the LPF 458 and the HPF 469) may be used regardless of whether the high band (e.g., the unit 410) is used for transmission or the low band (e.g., the unit 420) is used for transmission. Alternatively, the frequency of the IF transmit signal and the frequency of the IF feedback signal may be reversed depending on which band is being used for transmission. In this case, the LPF 458 and the HPF 469 may be replaced with filter devices each with a selectable filter characteristic that may be selected (e.g., by the controller 260) in order to pass the desired frequency and stop the undesired frequency.

Referring also to FIG. 6, using the transceiver 400, there may be IF frequency multiplexing within the same layer such that multiple IF signals (a transmit signal and a feedback signal) may be concurrently present on an I/O port. FIG. 6 shows that an IF transmit signal 610 at a first IF (IF1) may be converted using a first LO signal 612 of a first LO signal frequency LO1 to a radio frequency, amplified by a power amplifier 614 into an RF transmit signal 616, and transmitted from one of the units 410, 420, 430, 440 (FIG. 4) by an antenna 618. FIG. 6 further shows that the RF transmit signal 616 may be fed back through an amplifier 620 and converted, using a second LO signal 622 of a second LO signal frequency LO2 into an IF feedback signal 624 of a second IF frequency IF2. The IF transmit signal 610 and the IF feedback signal 624 are frequency multiplexed on an I/O port 630 such that the IF transmit signal 610 may be conveyed from a modem 640 and an IF IC 650 to the I/O port 630 for transmission, and the IF feedback signal 624 may be conveyed from the I/O port 630 to the IF IC 650 and to the modem 640 for analysis (e.g., measurement, decoding, etc.). An isolator 660 may be communicatively coupled to the I/O port 630 and configured to direct the IF transmit signal 610 into a transmit path (e.g., to a filter to pass the IF transmit signal and to suppress the IF feedback signal). The isolator 660 may be configured to direct the IF feedback signal 624 (e.g., from a filter that passes the IF feedback signal 624 and suppresses a frequency of the IF transmit signal) to the I/O port 630.

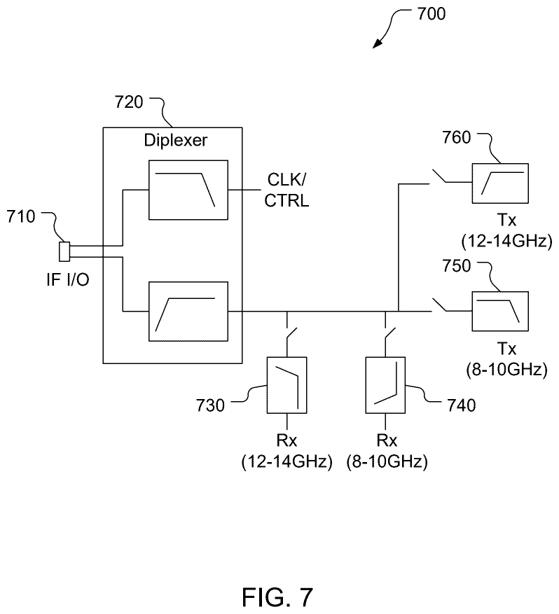

Referring also to FIG. 7, an example interface 700 includes an IF I/O port 710, a diplexer 720, and filters 730, 740, 750, 760. The filter 730 is selectively coupled to the diplexer 720 and configured to pass higher-frequency signals (in this example, above 12 GHz). The filter 730 may be configured as a band-pass filter to pass signals within a frequency window (e.g., between 12 GHz and 14 GHz). The filter 740 is selectively coupled to the diplexer 720 and configured to pass lower-frequency signals (in this example, below 10 GHz). The filter 740 may be configured as a band-pass filter to pass signals within a frequency window (e.g., between 8 GHz and 10 GHz). The filter 750 is selectively coupled to the diplexer 720 and configured to pass lower-frequency signals (in this example, below 10 GHz). The filter 750 may be configured as a band-pass filter to pass signals within a frequency window (e.g., between 8 GHz and 10 GHz). The filter 760 is selectively coupled to the diplexer 720 and configured to pass higher-frequency signals (in this example, above 12 GHz). The filter 760 may be configured as a band-pass filter to pass signals within a frequency window (e.g., between 12 GHz and 14 GHz). One of the filters 750, 760 may be eliminated, e.g., if the IF Tx signal is the same and the FBRX signal changes based on LB or HB operation. Both of the filters 750, 760 may be used where both the Tx IF frequency and the Rx IF frequency change. A feedback signal may be received by the filter 730 and passed to the diplexer 720. A transmit signal may be received by the filter 750 from the diplexer 720 and passed to transmit circuitry (not shown). The interface 700 provides a filter network to provide high impedance in out-of-band regions to reject unwanted signals in respective receive and transmit paths. Receive circuitry and/or transmit circuitry may have a bypass mode to bypass the filters 730, 740, or the filters 750, 760, respectively, in mission mode to reduce loss.

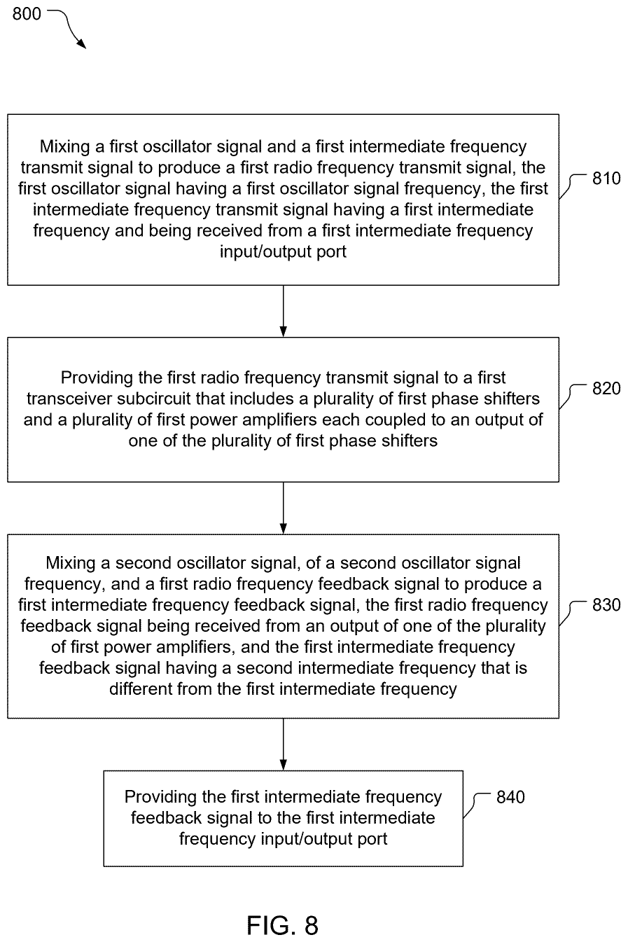

Referring to FIG. 8, with further reference to FIGS. 1-7, a method 800 of operating a transceiver integrated circuit includes the stages shown. The method 800 is, however, an example only and not limiting. The method 800 may be altered, e.g., by having one or more stages added, removed, rearranged, combined, performed concurrently, and/or by having one or more single stages split into multiple stages.

At stage 810, the method 800 includes mixing a first oscillator signal and a first intermediate frequency transmit signal to produce a first radio frequency transmit signal, the first oscillator signal having a first oscillator signal frequency, the first intermediate frequency transmit signal having a first intermediate frequency and being received from a first intermediate frequency input/output port. For example, the mixer 234 may mix the transmit signal 252 with the first oscillation signal 237 to produce an RF transmit signal (by changing the frequency of the transmit signal 252 from the first intermediate frequency IF1 to a radio frequency). As another example, the mixer 454 may mix the oscillator signal LO1 from the local oscillator 451 with the IF Tx signal from the IF I/O port 405 to produce the RF Tx signal. The mixer 234 or the mixer 454 may comprise means for mixing the first oscillator signal and the first IF transmit signal.

At stage 820, the method 800 includes providing the first radio frequency transmit signal to a first transceiver subcircuit that includes a plurality of first phase shifters and a plurality of first power amplifiers each coupled to an output of one of the plurality of first phase shifters. For example, the distribution network 221 or the distribution network 411 may convey the RF Tx signal to the phase shifters 222₁-222ₙ. The distribution network 221 or the distribution network 411 may provide means for providing the first radio frequency signal to the first transceiver subcircuit.

At stage 830, the method 800 includes mixing a second oscillator signal, of a second oscillator signal frequency, and a first radio frequency feedback signal to produce a first intermediate frequency feedback signal, the first radio frequency feedback signal being received from an output of one of the plurality of first power amplifiers, and the first intermediate frequency feedback signal having a second intermediate frequency that is different from the first intermediate frequency. For example, the mixer 244 may mix the FBRX signal 241 (from one of the power amplifiers 224₁-224ₙ) with the second oscillation signal 247 to produce the IF feedback signal 245 (by changing the frequency of the FBRX signal 241 to the second intermediate frequency IF2). As another example, the mixer 464 may mix the oscillator signal LO2 from the local oscillator 461 with the FBRX signal from one of the power amplifiers 224₁-224ₙ to produce an IF feedback signal with the second intermediate frequency IF2. The mixer 244 or the mixer 464 may comprise means for mixing the second oscillator signal and the first radio frequency feedback signal.

At stage 840, the method 800 includes providing the first intermediate frequency feedback signal to the first intermediate frequency input/output port. For example, the IF feedback signal may be conveyed from the mixer 244 to the I/O port 250 by the transmission line 249 (and possibly one or more other components). As another example, the IF feedback signal may be conveyed from the mixer 464 to the IF I/O port 405 by a transmission line 463 and the HPF 469 (and possibly one or more other components). The transmission line 463 and the HPF 469 may comprise means for providing the first intermediate frequency feedback signal to the first intermediate frequency input/output port.

Implementations of the method 800 may include one or more of the following features. In an example implementation, the first intermediate frequency feedback signal is provided to the first intermediate frequency input/output port while the first intermediate frequency transmit signal is present at the first intermediate frequency input/output port. For example, the IF Tx signal and the IF feedback signal may both be present concurrently at the I/O port 250 or the IF I/O port 405. In a further example implementation, the method 800 includes: filtering signals between the first intermediate frequency input/output port and a first mixer that mixes the first oscillator signal and the first intermediate frequency transmit signal to allow the first intermediate frequency transmit signal to pass and to suppress the first intermediate frequency feedback signal; and filtering signals between a second mixer, that mixes the second oscillator signal and the first radio frequency feedback signal, and the first intermediate frequency input/output port to allow the first intermediate frequency feedback signal to pass and to suppress the first intermediate frequency. For example, the LPF 458 allows signals of the first intermediate frequency IF1 to pass while rejecting signals of the second intermediate frequency IF2 and the HPF 469 458 allows signals of the second intermediate frequency IF2 to pass while rejecting signals of the first intermediate frequency IF1. The LPF 458 may comprise means for filtering signals between the first intermediate frequency input/output port and the means for mixing the first oscillator signal and the first intermediate frequency transmit signal. The HPF 469 may comprise means for filtering signals between the first intermediate frequency input/output port and the means for mixing the second oscillator signal and the first radio frequency feedback signal.

Also or alternatively, implementations of the method 800 may include one or more of the following features. In an example implementation, the method 800 includes: mixing a third oscillator signal and a second intermediate frequency transmit signal to produce a second radio frequency transmit signal, the third oscillator signal having a third oscillator signal frequency, the second intermediate frequency transmit signal having a third intermediate frequency and being received from a second intermediate frequency input/output port; providing the second radio frequency transmit signal to a second transceiver subcircuit that includes a plurality of second phase shifters and a plurality of second power amplifiers each coupled to an output of one of the plurality of second phase shifters; mixing a fourth oscillator signal, of a fourth oscillator signal frequency, and a second radio frequency feedback signal to produce a second intermediate frequency feedback signal, the second radio frequency feedback signal being received from an output of one of the plurality of second power amplifiers, and the second intermediate frequency feedback signal having a fourth intermediate frequency that is different from the third intermediate frequency; and providing the second intermediate frequency feedback signal to the second intermediate frequency input/output port. For example, equivalent counterparts of the circuitry 450, 460 in the V-layer of the transceiver 400 may operate similarly to the circuitry 450, 460 to feed back an IF feedback signal to an IF I/O port 406 concurrently with the presence of an IF transmit signal at the IF I/O port 406. In a further example implementation, the first oscillator signal is the third oscillator signal and the second oscillator signal is the fourth oscillator signal, and wherein the first oscillator signal frequency is the third oscillator signal frequency and the second oscillator signal frequency is the fourth oscillator signal frequency. For example, the same oscillator, e.g., the local oscillator 451, may be used to produce RF Tx signals for the unit 410 and the unit 430, and the same oscillator, e.g., the local oscillator 461, may be used to produce IF feedback signals from fed back transmit signals from the units 410, 430. In another further example implementation, the first intermediate frequency feedback signal is provided to the first intermediate frequency input/output port concurrently with the second intermediate frequency feedback signal being provided to the second intermediate frequency input/output port. For example, the units 410, 430 and the respective feedback circuitry may operate concurrently.

### IMPLEMENTATION EXAMPLES

Implementation examples are provided in the following numbered clauses.

Clause 1. A transceiver integrated circuit comprising:
a first intermediate frequency input/output port;
a first transceiver subcircuit including:
   a plurality of first power amplifiers each including a respective first power-amplifier output, of a plurality of first power-amplifier outputs, that is selectively communicatively coupled to a first radio frequency input/output port; and
   a plurality of first phase shifters each communicatively coupled to a first power-amplifier input of a respective one of the plurality of first power amplifiers;
a first oscillator configured to provide a first oscillator signal of a first oscillator signal frequency;
a first mixer communicatively coupled to the first intermediate frequency input/output port, communicatively coupled to the first oscillator, and communicatively coupled to the plurality of first power amplifiers via the plurality of first phase shifters, wherein the first mixer is configured to mix a first transmit signal, received from the first intermediate frequency input/output port, with the first oscillator signal to change a frequency of the first transmit signal from a first intermediate frequency to a first radio frequency;
a second oscillator configured to provide a second oscillator signal of a second oscillator signal frequency that is different from the first oscillator signal frequency; and
a second mixer communicatively coupled to the first intermediate frequency input/output port, communicatively coupled to the second oscillator, and selectively communicatively coupled to the first power-amplifier output of at least one of the plurality of first power amplifiers, wherein the second mixer is configured to mix a first feedback signal, received from the first power-amplifier output of a respective one of the plurality of first power amplifiers, with the second oscillator signal to change a frequency of the first feedback signal from the first radio frequency to a second intermediate frequency that is different from the first intermediate frequency.

Clause 2. The transceiver integrated circuit of clause 1, further comprising:
a controller; and
a plurality of switches, communicatively coupled to the controller, configured to respond to one or more instructions from the controller to communicatively couple the first mixer to the first intermediate frequency input/output port, and concurrently to communicatively couple the second mixer to a selected one of the plurality of first power-amplifier outputs to have the transmit signal, of the first intermediate frequency, and the first feedback signal, having the second intermediate frequency, present at the first intermediate frequency input/output port concurrently.

Clause 3. The transceiver integrated circuit of either clause 1 or clause 2, further comprising:
a first frequency filter communicatively coupled between the first intermediate frequency input/output port and the first mixer, and configured to provide a first pass band that includes the first intermediate frequency and to provide a first stop band, with a first cutoff frequency between the first intermediate frequency the second intermediate frequency; and
a second frequency filter communicatively coupled between the first intermediate frequency input/output port and the second mixer, and configured to provide a second pass band that includes the second intermediate frequency and to provide a second stop band, with a second cutoff frequency between the first intermediate frequency the second intermediate frequency.

Clause 4. The transceiver integrated circuit of any previous clause, further comprising:
a second intermediate frequency input/output port distinct from the first intermediate frequency input/output port;
a second transceiver subcircuit including:
   a plurality of second power amplifiers each including a respective second power-amplifier output, of a plurality of second power-amplifier outputs, that is selectively communicatively coupled to a second radio frequency input/output port; and
   a plurality of second phase shifters each communicatively coupled to a second power-amplifier input of a respective one of the plurality of second power amplifiers;
a third oscillator configured to provide a third oscillator signal of a third oscillator signal frequency;
a third mixer selectively communicatively coupled to the second intermediate frequency input/output port, communicatively coupled to the third oscillator, and communicatively coupled to the plurality of second power amplifiers via the plurality of second phase shifters, wherein the third mixer is configured to mix a second transmit signal, received from the second intermediate frequency input/output port, with the third oscillator signal to change a frequency of the second transmit signal from a third intermediate frequency to a second radio frequency;
a fourth oscillator configured to provide a fourth oscillator signal of a fourth oscillator signal frequency that is different from the third oscillator signal frequency; and
a fourth mixer communicatively coupled to the second intermediate frequency input/output port, selectively communicatively coupled to the fourth oscillator, and selectively communicatively coupled to the second power-amplifier output of at least one of the plurality of second power amplifiers, wherein the fourth mixer is configured to mix a second feedback signal, received from the second power-amplifier output of a respective one of the plurality of second power amplifiers, with the fourth oscillator signal to change a frequency of the second feedback signal from the second radio frequency to a fourth intermediate frequency that is different from the third intermediate frequency.

Clause 5. The transceiver integrated circuit of clause 4, wherein the first oscillator is the third oscillator and the second oscillator is the fourth oscillator, and wherein the first oscillator signal frequency is the third oscillator signal frequency and the second oscillator signal frequency is the fourth oscillator signal frequency.

Clause 6. The transceiver integrated circuit of claim 1, wherein the first mixer is a first transmit mixer and the second mixer is a second receive mixer, the transceiver integrated circuit further comprising:
a first receive mixer;
a second transmit mixer;
a first switch communicatively coupled to the first oscillator and configured to selectively communicatively couple the first oscillator to the first transmit mixer or to the first receive mixer; and
a second switch communicatively coupled to the first oscillator and configured to selectively communicatively couple the second oscillator to the second transmit mixer or to the second receive mixer.

Clause 7. The transceiver integrated circuit of claim 6, further comprising a controller communicatively coupled to the first switch and the second switch and configured to:
control the first switch and the second switch to cause the first switch to communicatively couple the first oscillator to the first transmit mixer and, concurrently, cause the second switch to communicatively couple the second oscillator to the second receive mixer; and
control the first switch and the second switch to cause the first switch to communicatively couple the first oscillator to the first receive mixer and, concurrently, cause the second switch to communicatively couple the second oscillator to the second transmit mixer.

Clause 8. The transceiver integrated circuit of claim 1, wherein the second mixer is selectively communicatively coupled to the first power-amplifier output of at least one of the plurality of first power amplifiers by a feedback line, and wherein the feedback line and the first radio frequency input/output port of each of the plurality of first power amplifiers are disposed proximate to a side of the transceiver integrated circuit.

Clause 9. The transceiver integrated circuit of claim 8, wherein at least a portion of the feedback line is disposed between the first radio frequency input/output port of at least one of the plurality of first power amplifiers and the side of the transceiver integrated circuit.

Clause 10. A method of operating a transceiver integrated circuit, the method comprising:
mixing a first oscillator signal and a first intermediate frequency transmit signal to produce a first radio frequency transmit signal, the first oscillator signal having a first oscillator signal frequency, the first intermediate frequency transmit signal having a first intermediate frequency and being received from a first intermediate frequency input/output port;
providing the first radio frequency transmit signal to a first transceiver subcircuit that includes a plurality of first phase shifters and a plurality of first power amplifiers each coupled to an output of one of the plurality of first phase shifters;
mixing a second oscillator signal, of a second oscillator signal frequency, and a first radio frequency feedback signal to produce a first intermediate frequency feedback signal, the first radio frequency feedback signal being received from an output of one of the plurality of first power amplifiers, and the first intermediate frequency feedback signal having a second intermediate frequency that is different from the first intermediate frequency; and
providing the first intermediate frequency feedback signal to the first intermediate frequency input/output port.

Clause 11. The method of clause 10, wherein the first intermediate frequency feedback signal is provided to the first intermediate frequency input/output port while the first intermediate frequency transmit signal is present at the first intermediate frequency input/output port.

Clause 12. The method of either clause 10 or clause 11, further comprising:
filtering signals between the first intermediate frequency input/output port and a first mixer that mixes the first oscillator signal and the first intermediate frequency transmit signal to allow the first intermediate frequency transmit signal to pass and to suppress the first intermediate frequency feedback signal; and
filtering signals between a second mixer, that mixes the second oscillator signal and the first radio frequency feedback signal, and the first intermediate frequency input/output port to allow the first intermediate frequency feedback signal to pass and to suppress the first intermediate frequency.

Clause 13. The method of any of clauses 10-12, further comprising:
mixing a third oscillator signal and a second intermediate frequency transmit signal to produce a second radio frequency transmit signal, the third oscillator signal having a third oscillator signal frequency, the second intermediate frequency transmit signal having a third intermediate frequency and being received from a second intermediate frequency input/output port;
providing the second radio frequency transmit signal to a second transceiver subcircuit that includes a plurality of second phase shifters and a plurality of second power amplifiers each coupled to an output of one of the plurality of second phase shifters;
mixing a fourth oscillator signal, of a fourth oscillator signal frequency, and a second radio frequency feedback signal to produce a second intermediate frequency feedback signal, the second radio frequency feedback signal being received from an output of one of the plurality of second power amplifiers, and the second intermediate frequency feedback signal having a fourth intermediate frequency that is different from the third intermediate frequency; and
providing the second intermediate frequency feedback signal to the second intermediate frequency input/output port.

Clause 14. The method of clause 13, wherein the first oscillator signal is the third oscillator signal and the second oscillator signal is the fourth oscillator signal, and wherein the first oscillator signal frequency is the third oscillator signal frequency and the second oscillator signal frequency is the fourth oscillator signal frequency.

Clause 15. The method of claim 13, wherein the first intermediate frequency feedback signal is provided to the first intermediate frequency input/output port concurrently with the second intermediate frequency feedback signal being provided to the second intermediate frequency input/output port.

Clause 16. A transceiver integrated circuit comprising:
means for mixing a first oscillator signal and a first intermediate frequency transmit signal to produce a first radio frequency transmit signal, the first oscillator signal having a first oscillator signal frequency, the first intermediate frequency transmit signal having a first intermediate frequency and being received from a first intermediate frequency input/output port;
means for providing the first radio frequency transmit signal to a first transceiver subcircuit that includes a plurality of first phase shifters and a plurality of first power amplifiers each coupled to an output of one of the plurality of first phase shifters;
means for mixing a second oscillator signal, of a second oscillator signal frequency, and a first radio frequency feedback signal to produce a first intermediate frequency feedback signal, the first radio frequency feedback signal being received from an output of one of the plurality of first power amplifiers, and the first intermediate frequency feedback signal having a second intermediate frequency that is different from the first intermediate frequency; and
means for providing the first intermediate frequency feedback signal to the first intermediate frequency input/output port.

Clause 17. The transceiver integrated circuit of clause 16, wherein the means for providing first intermediate frequency feedback signal are for providing the first intermediate frequency feedback signal to the first intermediate frequency input/output port while the first intermediate frequency transmit signal is present at the first intermediate frequency input/output port.

Clause 18. The transceiver integrated circuit of either clause 16 or clause 17, further comprising:
means for filtering signals between the first intermediate frequency input/output port and the means for mixing the first oscillator signal and the first intermediate frequency transmit signal to allow the first intermediate frequency transmit signal to pass and to suppress the first intermediate frequency feedback signal; and
means for filtering signals between the first intermediate frequency input/output port and the means for mixing the second oscillator signal and the first radio frequency feedback signal to allow the first intermediate frequency feedback signal to pass and to suppress the first intermediate frequency.

Clause 19. The transceiver integrated circuit of any of clauses 16-18, further comprising:
means for mixing a third oscillator signal and a second intermediate frequency transmit signal to produce a second radio frequency transmit signal, the third oscillator signal having a third oscillator signal frequency, the second intermediate frequency transmit signal having a third intermediate frequency and being received from a second intermediate frequency input/output port;
means for providing the second radio frequency transmit signal to a second transceiver subcircuit that includes a plurality of second phase shifters and a plurality of second power amplifiers each coupled to an output of one of the plurality of second phase shifters;
means for mixing a fourth oscillator signal, of a fourth oscillator signal frequency, and a second radio frequency feedback signal to produce a second intermediate frequency feedback signal, the second radio frequency feedback signal being received from an output of one of the plurality of second power amplifiers, and the second intermediate frequency feedback signal having a fourth intermediate frequency that is different from the third intermediate frequency; and
means for providing the second intermediate frequency feedback signal to the second intermediate frequency input/output port.

Clause 20. The transceiver integrated circuit of clause 19, wherein the first oscillator signal is the third oscillator signal and the second oscillator signal is the fourth oscillator signal, and wherein the first oscillator signal frequency is the third oscillator signal frequency and the second oscillator signal frequency is the fourth oscillator signal frequency.

### OTHER CONSIDERATIONS

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, the components may be directly or indirectly connected to enable signal transfer between the components. Communicative coupling includes selective communicative coupling, e.g., components each being coupled to a switch that may be controlled to open to isolate the components or be controlled to close to complete (at least a portion of) a connection between the components.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A transceiver integrated circuit comprising:
a first intermediate frequency input/output port;
a first transceiver subcircuit including:
a plurality of first power amplifiers each including a respective first power-amplifier output, of a plurality of first power-amplifier outputs, that is selectively communicatively coupled to a first radio frequency input/output port; and
a plurality of first phase shifters each communicatively coupled to a first power-amplifier input of a respective one of the plurality of first power amplifiers;
a first oscillator configured to provide a first oscillator signal of a first oscillator signal frequency;
a first mixer communicatively coupled to the first intermediate frequency input/output port, communicatively coupled to the first oscillator, and communicatively coupled to the plurality of first power amplifiers via the plurality of first phase shifters, wherein the first mixer is configured to mix a first transmit signal, received from the first intermediate frequency input/output port, with the first oscillator signal to change a frequency of the first transmit signal from a first intermediate frequency to a first radio frequency;
a second oscillator configured to provide a second oscillator signal of a second oscillator signal frequency that is different from the first oscillator signal frequency; and
a second mixer communicatively coupled to the first intermediate frequency input/output port, communicatively coupled to the second oscillator, and selectively communicatively coupled to the first power-amplifier output of at least one of the plurality of first power amplifiers, wherein the second mixer is configured to mix a first feedback signal, received from the first power-amplifier output of a respective one of the plurality of first power amplifiers, with the second oscillator signal to change a frequency of the first feedback signal from the first radio frequency to a second intermediate frequency that is different from the first intermediate frequency.

2. The transceiver integrated circuit of claim 1, further comprising:
a controller; and
a plurality of switches, communicatively coupled to the controller, configured to respond to one or more instructions from the controller to communicatively couple the first mixer to the first intermediate frequency input/output port, and concurrently to communicatively couple the second mixer to a selected one of the plurality of first power-amplifier outputs to have the transmit signal, of the first intermediate frequency, and the first feedback signal, having the second intermediate frequency, present at the first intermediate frequency input/output port concurrently.

3. The transceiver integrated circuit of claim 2, further comprising:
a first frequency filter communicatively coupled between the first intermediate frequency input/output port and the first mixer, and configured to provide a first pass band that includes the first intermediate frequency and to provide a first stop band, with a first cutoff frequency between the first intermediate frequency the second intermediate frequency; and
a second frequency filter communicatively coupled between the first intermediate frequency input/output port and the second mixer, and configured to provide a second pass band that includes the second intermediate frequency and to provide a second stop band, with a second cutoff frequency between the first intermediate frequency the second intermediate frequency.

4. The transceiver integrated circuit of claim 1, further comprising:
a second intermediate frequency input/output port distinct from the first intermediate frequency input/output port;
a second transceiver subcircuit including:
a plurality of second power amplifiers each including a respective second power-amplifier output, of a plurality of second power-amplifier outputs, that is selectively communicatively coupled to a second radio frequency input/output port; and
a plurality of second phase shifters each communicatively coupled to a second power-amplifier input of a respective one of the plurality of second power amplifiers;
a third oscillator configured to provide a third oscillator signal of a third oscillator signal frequency;
a third mixer selectively communicatively coupled to the second intermediate frequency input/output port, communicatively coupled to the third oscillator, and communicatively coupled to the plurality of second power amplifiers via the plurality of second phase shifters, wherein the third mixer is configured to mix a second transmit signal, received from the second intermediate frequency input/output port, with the third oscillator signal to change a frequency of the second transmit signal from a third intermediate frequency to a second radio frequency;
a fourth oscillator configured to provide a fourth oscillator signal of a fourth oscillator signal frequency that is different from the third oscillator signal frequency; and
a fourth mixer communicatively coupled to the second intermediate frequency input/output port, selectively communicatively coupled to the fourth oscillator, and selectively communicatively coupled to the second power-amplifier output of at least one of the plurality of second power amplifiers, wherein the fourth mixer is configured to mix a second feedback signal, received from the second power-amplifier output of a respective one of the plurality of second power amplifiers, with the fourth oscillator signal to change a frequency of the second feedback signal from the second radio frequency to a fourth intermediate frequency that is different from the third intermediate frequency.

5. The transceiver integrated circuit of claim 4, wherein the first oscillator is the third oscillator and the second oscillator is the fourth oscillator, and wherein the first oscillator signal frequency is the third oscillator signal frequency and the second oscillator signal frequency is the fourth oscillator signal frequency.

6. The transceiver integrated circuit of claim 1, wherein the first mixer is a first transmit mixer and the second mixer is a second receive mixer, the transceiver integrated circuit further comprising:
a first receive mixer;
a second transmit mixer;
a first switch communicatively coupled to the first oscillator and configured to selectively communicatively couple the first oscillator to the first transmit mixer or to the first receive mixer; and
a second switch communicatively coupled to the first oscillator and configured to selectively communicatively couple the second oscillator to the second transmit mixer or to the second receive mixer.

7. The transceiver integrated circuit of claim 6, further comprising a controller communicatively coupled to the first switch and the second switch and configured to:
control the first switch and the second switch to cause the first switch to communicatively couple the first oscillator to the first transmit mixer and, concurrently, cause the second switch to communicatively couple the second oscillator to the second receive mixer; and
control the first switch and the second switch to cause the first switch to communicatively couple the first oscillator to the first receive mixer and, concurrently, cause the second switch to communicatively couple the second oscillator to the second transmit mixer.

8. The transceiver integrated circuit of claim 1, wherein the second mixer is selectively communicatively coupled to the first power-amplifier output of at least one of the plurality of first power amplifiers by a feedback line, and wherein the feedback line and the first radio frequency input/output port of each of the plurality of first power amplifiers are disposed proximate to a side of the transceiver integrated circuit.

9. The transceiver integrated circuit of claim 8, wherein at least a portion of the feedback line is disposed between the first radio frequency input/output port of at least one of the plurality of first power amplifiers and the side of the transceiver integrated circuit.

10. A method of operating a transceiver integrated circuit, the method comprising:
mixing a first oscillator signal and a first intermediate frequency transmit signal to produce a first radio frequency transmit signal, the first oscillator signal having a first oscillator signal frequency, the first intermediate frequency transmit signal having a first intermediate frequency and being received from a first intermediate frequency input/output port;
providing the first radio frequency transmit signal to a first transceiver subcircuit that includes a plurality of first phase shifters and a plurality of first power amplifiers each coupled to an output of one of the plurality of first phase shifters;
mixing a second oscillator signal, of a second oscillator signal frequency, and a first radio frequency feedback signal to produce a first intermediate frequency feedback signal, the first radio frequency feedback signal being received from an output of one of the plurality of first power amplifiers, and the first intermediate frequency feedback signal having a second intermediate frequency that is different from the first intermediate frequency; and
providing the first intermediate frequency feedback signal to the first intermediate frequency input/output port.

11. The method of claim 10, wherein the first intermediate frequency feedback signal is provided to the first intermediate frequency input/output port while the first intermediate frequency transmit signal is present at the first intermediate frequency input/output port.

12. The method of claim 11, further comprising:
filtering signals between the first intermediate frequency input/output port and a first mixer that mixes the first oscillator signal and the first intermediate frequency transmit signal to allow the first intermediate frequency transmit signal to pass and to suppress the first intermediate frequency feedback signal; and
filtering signals between a second mixer, that mixes the second oscillator signal and the first radio frequency feedback signal, and the first intermediate frequency input/output port to allow the first intermediate frequency feedback signal to pass and to suppress the first intermediate frequency.

13. The method of claim 10, further comprising:
mixing a third oscillator signal and a second intermediate frequency transmit signal to produce a second radio frequency transmit signal, the third oscillator signal having a third oscillator signal frequency, the second intermediate frequency transmit signal having a third intermediate frequency and being received from a second intermediate frequency input/output port;
providing the second radio frequency transmit signal to a second transceiver subcircuit that includes a plurality of second phase shifters and a plurality of second power amplifiers each coupled to an output of one of the plurality of second phase shifters;
mixing a fourth oscillator signal, of a fourth oscillator signal frequency, and a second radio frequency feedback signal to produce a second intermediate frequency feedback signal, the second radio frequency feedback signal being received from an output of one of the plurality of second power amplifiers, and the second intermediate frequency feedback signal having a fourth intermediate frequency that is different from the third intermediate frequency; and
providing the second intermediate frequency feedback signal to the second intermediate frequency input/output port.

14. The method of claim 13, wherein the first oscillator signal is the third oscillator signal and the second oscillator signal is the fourth oscillator signal, and wherein the first oscillator signal frequency is the third oscillator signal frequency and the second oscillator signal frequency is the fourth oscillator signal frequency.

15. The method of claim 13, wherein the first intermediate frequency feedback signal is provided to the first intermediate frequency input/output port concurrently with the second intermediate frequency feedback signal being provided to the second intermediate frequency input/output port.

16. A transceiver integrated circuit comprising:
means for mixing a first oscillator signal and a first intermediate frequency transmit signal to produce a first radio frequency transmit signal, the first oscillator signal having a first oscillator signal frequency, the first intermediate frequency transmit signal having a first intermediate frequency and being received from a first intermediate frequency input/output port;
means for providing the first radio frequency transmit signal to a first transceiver subcircuit that includes a plurality of first phase shifters and a plurality of first power amplifiers each coupled to an output of one of the plurality of first phase shifters;
means for mixing a second oscillator signal, of a second oscillator signal frequency, and a first radio frequency feedback signal to produce a first intermediate frequency feedback signal, the first radio frequency feedback signal being received from an output of one of the plurality of first power amplifiers, and the first intermediate frequency feedback signal having a second intermediate frequency that is different from the first intermediate frequency; and
means for providing the first intermediate frequency feedback signal to the first intermediate frequency input/output port.

17. The transceiver integrated circuit of claim 16, wherein the means for providing first intermediate frequency feedback signal are for providing the first intermediate frequency feedback signal to the first intermediate frequency input/output port while the first intermediate frequency transmit signal is present at the first intermediate frequency input/output port.

18. The transceiver integrated circuit of claim 17, further comprising:
means for filtering signals between the first intermediate frequency input/output port and the means for mixing the first oscillator signal and the first intermediate frequency transmit signal to allow the first intermediate frequency transmit signal to pass and to suppress the first intermediate frequency feedback signal; and
means for filtering signals between the first intermediate frequency input/output port and the means for mixing the second oscillator signal and the first radio frequency feedback signal to allow the first intermediate frequency feedback signal to pass and to suppress the first intermediate frequency.

19. The transceiver integrated circuit of claim 16, further comprising:
means for mixing a third oscillator signal and a second intermediate frequency transmit signal to produce a second radio frequency transmit signal, the third oscillator signal having a third oscillator signal frequency, the second intermediate frequency transmit signal having a third intermediate frequency and being received from a second intermediate frequency input/output port;
means for providing the second radio frequency transmit signal to a second transceiver subcircuit that includes a plurality of second phase shifters and a plurality of second power amplifiers each coupled to an output of one of the plurality of second phase shifters;
means for mixing a fourth oscillator signal, of a fourth oscillator signal frequency, and a second radio frequency feedback signal to produce a second intermediate frequency feedback signal, the second radio frequency feedback signal being received from an output of one of the plurality of second power amplifiers, and the second intermediate frequency feedback signal having a fourth intermediate frequency that is different from the third intermediate frequency; and
means for providing the second intermediate frequency feedback signal to the second intermediate frequency input/output port.

20. The transceiver integrated circuit of claim 19, wherein the first oscillator signal is the third oscillator signal and the second oscillator signal is the fourth oscillator signal, and wherein the first oscillator signal frequency is the third oscillator signal frequency and the second oscillator signal frequency is the fourth oscillator signal frequency.
